(19) United States
(12) Patent Application Publication
(10) Pub. No.: US 2020/0047992 A1
(43) Pub. Date: Feb. 13, 2020

(54) MOBILE STORAGE CONTAINER FOR BULK GOODS

(71) Applicant: Werner GmbH & Co Straßenreinigung KG, München (DE)

(72) Inventor: Hans Werner, Munchen (DE)

(21) Appl. No.: 16/483,821

(22) PCT Filed: Feb. 13, 2018
(86) PCT No.: PCT/EP2018/053484

§ 371 Date: Aug. 6, 2019

(30) Foreign Application Priority Data
Feb. 16, 2017 (DE) 10 2017 202 505.0

(51) Int. Cl. B65D 88/54; B65D 88/12; B65G 65/46; E01H 10/00

(52) U.S. Cl. CPC B65D 88/546; B65D 88/126; B65G 2814/0264; E01H 10/002; B65G 2201/045; B65G 65/463

(57) ABSTRACT

The invention relates to a mobile storage container for bulk material in the form of a container unit which is dimensioned such that it can be transported on public roads and in public areas without requiring special permits for said transport. The container unit has a container with sidewalls, an underfloor, and an intermediate bottom arranged above the underfloor. The container has a stiffness that allows for the container to be set up even in the filled state on any essentially level ground without pillar mounting and without a foundation. A discharge device for the bulk material and a cross conveyor are integrated into the container, and a vertical conveyor connected to the discharge device is integrated into the container unit. By means of the discharge device, the bulk material is dispensed at a discharge height from the container unit and transferred to the vertical conveyor. From the vertical conveyor, the bulk material is dispensed at a drop height, which is higher than the discharge height.

The invention relates to a mobile storage container for bulk materials in the form of a container unit, wherein the container unit is dimensioned such that it can be transported without a special permit on public roads and in public areas, and so the storage container is a mobile storage container.

The storage container is provided, so that a bulk material to be stored, which can preferably be road salt, road sand, or road grit for the winter service, is mobile, i.e. that said storage container can be transported from one location to another. In the following, storage container shall refer to a container that stores bulk material, while a transport container is a container, with which goods are transported from one location to another, which is subsequently followed by an earliest possible unloading of the transported goods. However, the present invention concerns a storage container, in which bulk materials are also supposed to be stored for longer periods, wherein said storage container is supposed to be transportable by conventional means of transportation, such as trucks, on public roads and in public areas without a special permit.

Storage containers as well as transport containers for the daily handling of bulk materials are known. There is a multiplicity of storage and/or transport tasks, for which respective containers are offered which are usually adjusted to the individual transport tasks. In particular, the loading and unloading of the means of transportation, especially with regard to bulk materials, is not trivial and may also require additional intermediate containers, both in connection with the loading and unloading of the bulk materials as well as possibly necessary transfer processes.

Commercially available containers exist, for example, as roll-off or skip containers as well as, with regard to their dimensions, the ISO sea containers. These containers for bulk material often have discharge devices which are arranged at the bottom of the container and which, in a gravity-supported manner, discharge the bulk material in a downward direction. This takes place below the lowest point of the container in its operating position. With this working principle of emptying, it is assumed for the container that the necessary and subsequent conveyor systems, which receive and further transport the bulk material falling from the container, are arranged below the container, that the container is placed sufficiently high during emptying in order to ensure a direct transfer of the bulk material to the subsequent usage unit, or that the bulk material is dumped on the ground or the container is emptied onto the ground, so that a further machine, such as a wheel loader, is required for further transport of the dumped bulk material. The subsequent conveyor systems or usage facilities to be provided are stationary or semi-mobile and always arranged separately from the actual container. The biggest problems for completely mobile systems arise at the interface between transport, storage, and usage of the bulk materials.

In addition, and this presents a serious limitation, it must be noted that the weight restriction of rolling vehicles in public traffic, i.e. with swap bodies or containers of all kinds of designs, limits a full utilization of the capacity of the container. Examples hereto are road vehicles or also rail vehicles. With regard to the weight limitation for a transport with a truck approved for public traffic, a three-axle truck, for example, has a maximally permissible total weight of 26 t and a tractor-trailer has a maximally permissible total weight of 40 t. After deducting the net weight of the respective vehicles, this results in a maximum load capacity of 13 t for a three-axle truck, and 25t for a tractor-trailer. The load volume for a three-axle truck is up to 40 m³; that for a tractor-trailer is up to 100 m³. These numerical values refer to the permitted values in Germany. In other countries, these figures may vary. However, this means that, based on the density of the bulk material to be transported, the vehicles cannot completely fill their containers when heavy bulk materials are loaded. This refers to the containers not being used to capacity, which means that the entire load volume cannot be utilized because the permissible total weight would otherwise be exceeded. Therefore, this raises the problem of a significant discrepancy between the possible load volume of trucks and the associated load capacity in terms of weight.

However, many trucks use swap bodies, such as ISO containers, swap platforms, but also skip and roll-off containers. However, the above-mentioned discrepancies between volume and weight similarly apply to these swap bodies. In known container services, a roll-off or skip container is usually transported by means of container truck to the customer who fills it. Subsequently, said container is again loaded by the container truck. This is especially problematic if the customer is not sufficiently aware of the loaded quantities and the containers are overloaded with regard to weight. There have been incidents where the container trucks were not even able to move the overloaded containers at all.

This results in further problems, especially when vehicles are not able to load enough bulk material for an intended use and must therefore constantly drive back to the base during operation to pick up reloads. This is the case especially for the winter service when it becomes necessary to work with relatively small vehicles to transport heavy bulk materials, such as grit for roads and paths. The thus relatively small quantities to be transported are used up quickly, and so, under certain circumstances, the travel times back to the base take longer than the actual operating times. This is problematic especially for the winter service because the softening and/or thawing of public roads and paths with grit and/or salt requires more time than is actually necessary.

The most common and customary storage containers are stationary tower silos built on substantial foundations. Despite the relatively great height of these tower silos, the load volume realized with these storage containers is relatively small, and so frequent refilling is required, which is very often realized by pneumatic conveying of the refill material. The small load volumes are also problematic because, especially on weekends or holidays, when the suppliers of the bulk material do not deliver, a continuous provision of the bulk material is not ensured around the clock. The operators of the tower silo can only remedy this problem by providing a permanent warehouse, in which the bulk material is dumped, and so from there, the bulk material can be loaded onto a respective transport vehicle and transported to and filled into the tower silo. The permanent warehouse has thus all the disadvantages of a central warehouse.

As already mentioned, the limited storage capacity and the stationary arrangement of the storage containers, such as the tower silos, are, for example, particularly important for the winter service.

Bulk material, particularly grit, particularly salt and loose gravel for the winter service, is mainly stored in permanent structures, such as warehouses with a capacity of several 100 m³ as well as tower silos. In general, a distinction is made between mobile tower silos of up to 10 m³ storage volume and stationary tower silos with more than 10 m³ storage volume. In addition, there are the so-called loose gravel bins with a very small volume, which are usually used only for smaller surfaces to be gritted or salted, such as sidewalks and the like. If gritting material required for the winter service is subjected to a dry storage in covered storage areas, such as warehouses, it is possible to quantitatively store a sufficient amount of grit. However, it is disadvantageous that the warehouses are stationary, and long drives are frequently required, so that relatively long empty runs are initially required by the carrier vehicles to refill the grit containers. The larger the field of application of winter service vehicles or the farther the distance between the application area and the storage facility, the longer the empty runs back to the point where the gritting material is stored, so that more time is also required for the empty runs which become longer and longer. As a result, the effective operating times of the gritting vehicles during winter service are reduced. This is very disadvantageous, especially for the practical realization because according to current case law, a so-called round-trip time of 3 hours must be ensured.

This problem applies similarly to stationary tower silos of more than 10 m³. The larger the storage volume of the tower silos, the greater the costs for statics and foundation design, and so a significant additional cost factor must also be taken into consideration. If gritting material in the sense of a dry storage is supposed to be arranged in mobile tower silos, e.g. when used on company grounds, parking lots, sidewalks, and parks, etc., it is advantageous that these smaller mobile tower silos with a respective silo size of, e.g. 3.5 m³; 5 m³, or 10 m³ storage capacity can be set up in strategically favorable locations. However, the relatively low storage capacity requires relatively frequent refilling in case of longer lasting winter service operations, during which several vehicles usually wish to withdraw gritting material consecutively. In case of continuous snowfall, this can lead to significant logistical problems during filling, with the result that winter service work cannot be executed with ensured quality or in a sufficiently short time, which can possibly be associated with liability problems for the operators or contractors of the winter service work.

It must also be noted that even with the mobile silos, a special device is required for filling or refilling, e.g. a truck with a corresponding loading crane or with respective additional expensive, pneumatically conveying vehicles. When using a loading crane, the required overhead filling of the tower silos takes place at least at a height of about 4.5 to 6.5 m, depending on the size of the silo. It is also disadvantageous that during the refilling, it is not apparent whether and to what extent the silo is already filled. This frequently results in problems, such as loose gravel being unloaded next to the filling opening at the end of the filling process.

Winter service is carried out mainly with trucks—Unimogs, Ladogs, Tremos, and the like—because these carrier vehicles usually have a cargo area for grit. A preferably large cargo area for transporting grit is extremely important because for the winter service, short round-trip times are stipulated, during which only short and preferably few empty runs take place. For the winter service, these carrier vehicles mentioned are expensive with regard to acquisition and maintenance, especially also because a year-round utilization is sometimes difficult to realize. This is especially true for Unimogs. With smaller vehicles or large tractors, the costs are lower, and these vehicles can be used throughout the year with more flexibility. However, the low load volume for grit represents a significant limitation for the use of these smaller vehicles. The advantage of the large equipment carriers is precisely the large load volume for grit, which makes it possible to comply with the stipulated short round-trip times with few empty runs during the winter service. Due to the small load quantity of grit, the smaller winter service vehicles require a relatively high number of empty runs.

From a company brochure by HUNING Maschinenbau, a sludge stacking and loading system with a compact design is known. This refers to a larger container which is set up stationarily on a foundation and mounted on pillars, and which, in any case, is not suitable for normal road traffic without a special permit due to its dimensions. The known system is further disadvantageous because additional devices, e.g. a vertical auger, are attached to the outside of this container, which further increases the outer dimensions and therefore all the more dictates only a stationary use of the known system. The containers described are intended for the drainage of sludges, wherein the loading auger is arranged below the underfloor of the container, and so this storage container must necessarily be mounted on a foundation and pillars. For a flexible use for bulk material, especially for the winter service, when the bulk material is grit, such stationary, i.e. non-mobile loading containers are decidedly disadvantageous for reasons of total costs.

From the company brochure by Tiek Anlagen- und Maschinenbau, commercially available roll containers and pillar-mounted containers are known which require a set-up height with respect to their underfloor, resulting in the discharge device being arranged in an area at least partially below the floor level. This is realized with rollers and existing rails, which, however, require that the installation or set-down location of such containers must be on solid ground because the rails would otherwise readily sink into loose soil due to the high surface pressure. As a result, a planar orientation of these containers would no longer be ensured. Also known from this company brochure is a discharge device in such a container in the form of a push floor discharge. These containers are used mainly for shavings. This push floor discharge is arranged within the container above the underfloor. However, for the intended use according to the present invention, these containers are disadvantageous.

Furthermore, it is apparent from a company brochure by FSE Pico/Brandt GmbH that containers, which are provided for biogas systems and can also contain general cargo, must overall not only be pillar-mounted but also arranged at a defined height level, and the discharge device, which discharges downwards, must be high enough to ensure that a conveyance from the container into or onto a truck for transporting the discharged bulk material is possible.

Therefore, the present invention addresses the problem of providing a storage container which is limited in its size such that, with regard to its maximum dimensions, it is suitable for respective trucks approved for public transport on public roads and in public areas. In other words, a mobile storage container is supposed to be provided which can be set up temporarily as a storage container at an operating location, from which bulk material can be conveyed, and which can also be refilled, but which, after conclusion of the operation, can readily be transported to a new operating location, and so the empty runs with the vehicles can overall be minimized especially during winter service.

This problem is solved by a mobile storage container having the features according to claim 1. Advantageous developments are defined in the dependent claims.

According to the invention, a mobile storage container for bulk material is designed in the form of a container unit which is dimensioned such, i.e. has such outer dimensions, that it can be transported without a special permit on public roads and in public areas with conventional trucks or vehicles specially provided for that purpose. Furthermore, the container unit has a container with sidewalls, an underfloor which is preferably open or closed, and an intermediate bottom arranged above the underfloor. Preferably, the intermediate bottom extends essentially plane-parallel to the underfloor from one sidewall to the other sidewall.

According to the invention, the underfloor or the container has a stiffness that allows for the container to be set up on level ground even in the filled state, i.e. neither a mounting on pillars nor a foundation is required for setting up the container. As long as the ground is fairly level, the container can be placed on any ground. This can be sandy soil or it can be grassy ground, but it can also be paved or concrete ground or simply consolidated soil. For that purpose, the stiffness of such a container must be greater than that of a pure transport container. The underfloor is designed such that the container does not sink in even on soft ground and can be reloaded by the truck after use. The underfloor does not have to be designed to be closed but must have a sufficiently large base area to reduce the surface pressure to the extent that sinking is prevented. A discharge device for the bulk material and optionally a cross conveyor are integrated into the container. In addition, a vertical conveyor connected to the discharge device or the cross conveyor is integrated into the container unit. By means of the discharge device, optionally after the cross conveyor, the bulk material is discharged from the container unit at a discharge height and transferred to the vertical conveyor. The bulk material can be dispensed by the vertical conveyor at a drop height which is higher than the discharge height. For emptying the container for the purpose of loading a vehicle in order to transport the unloaded bulk material, such as grit for roads and areas for winter services, to the location where it is needed, it is thus no longer necessary to drive under the container, as is the case with tower silo containers, or to pillar-mount or set up the container or the container unit on a foundation with a defined distance above the ground in order to install possibly existing aggregates below the bottom.

In the case of the mobile storage container solution according to the invention, the underfloor rests essentially on the installation site, without aggregates impeding in any way on the outside of the underfloor. As a container, a standardized container is preferably used which is designed specifically in accordance with the usual standardized container dimensions or has been rebuilt as an existing container for the purpose of a mobile storage container. As mobile storage containers in the form of containers, i.e. mobile containers, roll-off or skip containers are preferably used, which can be received, transported, and deposited again at the operating location by vehicles with commercial vehicle structures.

The containers constitute the main part of the container unit of the mobile storage container and according to the invention, they are provided with an integrated bulk material discharge in the form of the discharge device. Optionally, the discharge device has a collecting conveyor, herein also called a cross conveyor, and so after the discharge of the bulk material into the collecting conveyor, the bulk material is conveyed to the discharge height by means of the vertical conveyor. Integrated discharge device or integrated vertical conveyor is supposed to refer to the fact that these inventive devices of the mobile storage container are installed in the container unit, and so the outer dimensions correspond to the standardized container dimensions. If the devices, such as the vertical conveyor, are attached on the outer side, i.e. on an outer wall of the container, the container with its outer dimensions plus the add-on device must not be larger than the maximum width or length of a standardized container.

For that purpose, the discharge height, to which the bulk material is conveyed by means of the vertical conveyor, is arranged such that said bulk material can be received directly by vehicles that drive under the discharge height. The advantage of such an arrangement is that the container of the mobile storage container does not have to be tilted when emptied or that openings in the walls have to be opened. In order for the storage container to be mobile in accordance with the invention, wherein mobility refers to the permissible option for the mobile storage container to be received by conventional transport vehicles, such as trucks, and transported on public roads from one operating location to another without an additional permit, said storage container or the container unit is dimensioned such that all permissible transport dimensions and, of course, transport weights for a transport of the storage container in public spaces is possible without a special permit.

According to the general structure of the container unit, the material flow, i.e. the movement of the bulk material within the device while maintaining all permissible outer dimensions of the container unit for public road transport, including all integrated installation and add-on parts, is initially designed essentially horizontally to the collecting conveyor or the cross conveyor, wherein the bulk material, supported by gravity, falls into the collecting device or the cross conveyor, and at the end of the collecting device or the cross conveyor is, essentially with a vertical component, by means of the vertical conveyor, conveyed upwardly, namely to the discharge height, where the upwardly conveyed bulk material can be transferred to a utilization device or a further conveyor. The cross conveyor can be both an active conveying member, e.g. an auger or a tube chain conveyor, as well as a passive conveying member, for example, in the form of a funnel, in which the conveying takes place, for example, due to gravity or the thrust of the discharge member.

Due to the fact that the mobile storage container according to the invention can be placed with its underfloor directly on the ground at the set-up location, a very space-saving design can be realized. Above all, no foundations, pedestals or set-up frames for the container are required. Stationary emptying devices are also not required because the mobile storage container is also autarkic with regard to emptying the bulk material from its interior into commercial vehicles. The vertical conveyor can further comprise a cantilever arm which ends at the discharge height. Said cantilever arm is preferably designed with such a length that, for receiving the bulk material, vehicles can drive next to the mobile storage container, where they can readily and without an additional further conveyor receive the bulk material conveyed to the discharge height.

Preferably, the container unit is additionally provided with a loading device, for example, in the form of a shaft or a chute, from which the container can be filled with new bulk material by means of an additional integrated further conveying aggregate in order to fully utilize its volume and, when required, distribute the bulk material quantity stored in the mobile storage container to commercial vehicles for its distribution to respective desired locations. The additional conveying aggregate can be driven separately and designed separately; however, it can also be combined with the vertical conveyor. Further preferably, it is possible that the bulk material in the interior of the container of the container unit is evenly distributed by means of an integrated distribution device. This can preferably be designed to be combined with the loading device. However, it is also possible that a separate additional aggregate is provided for this purpose.

With this new type of mobile storage container which has the advantages of a flexible storage facility for bulk material and is designed autarkically for the distribution of the bulk material contained in it, the actual storage container is provided with an essential additional function, namely with the transport function, in order to be able to transport the storage container to any location with simple means, namely normal trucks. At the same time, the container unit is designed as a combination with the loading and/or unloading device as one unit. It is thus possible for the container unit to be transported with commercial trucks to and deposited at desired application locations, and so a flexible storage is ensured. Previous containers to be transported were used solely for transport, but were not designed as autarkic containers that realize numerous functions necessary for storage.

When transporting the mobile storage container, the weight of the bulk material received in said container is limited to the maximum load weight of the truck. Depending on the density of the bulk material, it can therefore be necessary that, for transport purposes, the mobile storage container is not completely filled. Instead, the container is filled completely at the set-up location, and so the filling of commercial vehicles can once again be realized from an essentially full storage container. Due to the subsequent complete filling, the maximum permissible total weight of the truck can be observed for the transport, and the full capacity of the mobile storage container can still be provided for its subsequent use. With regard to the flexibility and utilization of the mobile storage container, this constitutes a new quality for the provision of bulk material, particularly, for example, grit for winter services. This ensures that, due to the mobile storage container according to the invention, a relatively large storage space for bulk material is available on site without great effort, and said mobile storage container can also be transported flexibly to further locations. Prior to the return transport or the transport to another operating location, it must merely be ensured that the container of the container unit of the mobile storage container is emptied to the extent that the maximum permissible transport weight is not exceeded when it is loaded onto a truck.

In the container of the container unit, an intermediate bottom is provided, on which the bulk material is stored in the container. The transfer of the bulk material from the discharge device to the vertical conveyor integrated into the container takes place in the space between the intermediate bottom and the actual container bottom, i.e. the underfloor. Thus, there is no component which is arranged entirely or partially below the base frame of the bottom of the container or the container unit, and so the set-up on a level surface is ensured.

In order to make optimal use of the installation space in the interior of the container, the intermediate bottom can be designed to be completely or also partially inclined. In a preferred development, it would basically also be possible that the underfloor is not present as a continuous bottom; instead, only a support frame arranged from the imaginary underfloor to the intermediate bottom is provided, with the intermediate bottom resting on said support frame, and, for example, a discharge device being arranged on said intermediate bottom. In principle, such a design of the container unit is possible, but it limits possible set-up locations such that in this case, a solid ground is required because, e.g. on soft ground, such as sandy soil, the container with this support frame might sink into this soft ground.

The essential advantage of a closed underfloor according to the invention is precisely that no further components are attached below the underfloor, and so the container can be set up at almost any location, without foundations, pedestals or the like having to be installed or provided. Special requirements otherwise to be met concerning statics or test statics for handling the container are thus eliminated, which greatly expands the use of the mobile storage container according to the invention. If the outer design of the container unit is such that it corresponds to the simple outer walls of a conventional standardized container, which ensures easy and reliable handling despite mobility for the transport, it can be advantageous that all components integrated into the container are arranged in the interior, which limits the storage capacity of the mobile storage container but ensures the maximum transport dimensions, and so the mobile storage container can be transported without a permit in public spaces from one operating location to a further operating location. This can be ensured, for example, by also placing the drive motor of the cross conveyor in the container. Of course, this affects the length of the cross conveyor, i.e. its length must be shortened by the installation length of the drive. In order to ensure that the possible storage volume in the mobile storage container is not additionally reduced, the discharge device is preferably provided with corresponding plate-like deflectors in the area of these interruptions of, e.g. the cross conveyor.

The vertical conveyor is preferably designed as a vertical auger and arranged in the interior of the container. According to a development, the vertical auger is attached to the outside of the container. The use of augers for the transport of bulk material is particularly effective and possible with moderate driving power. Since the mobile storage container is designed as an autarkic container, the optimization of the required drive energy for the respective integrated functional units is of extreme importance. In the simplest case, the discharge device is designed as a funnel, and so, due to gravity, the bulk materials slide into the cross conveyor located below. The cross conveyor is called cross conveyor or also collecting conveyor because it usually collects the bulk material from the discharge device and is geometrically usually arranged transversely to the opening of the discharge device.

The discharge device is preferably designed as a push/pull bottom and has ladder rails and ladder bars. The design as a push or pull bottom has the advantage that it is arranged on the intermediate bottom or in the area of the intermediate bottom and transports the bulk material lying on the push bottom to the discharge device with its back-and-forth movement. In order to ensure a reliable transport of the bulk material during the back-and-forth movement of the push bottom, the ladder bars of the push bottom have wedges which are arranged in the same direction and have wedge tips and wedge end faces, wherein the tips each point in the same direction, similarly to the wedge end faces, which all face in the opposite direction of the wedge tips. This wedge arrangement has the advantage that, depending on the movement direction of the push floor, a wedge end face conveys the bulk material in the corresponding movement direction, while the wedge tips, with the respective movement direction in the direction of the wedge tips, allow for the bulk material to slide over the wedges with little resistance. Unless the collecting device or the cross conveyor is not arranged at the end of the push/pull bottom, the wedges on the shorter side of the intermediate bottom are arranged opposite to those on the longer side. The push bottom thus conveys when the longer side moves in the direction of the collecting device while on the shorter side, it slides under the bulk material. When the longer side moves against the direction of the collecting device, the push/pull bottom conveys on the shorter side, while the longer side slides under the bulk material.

Further preferably, the cross conveyor or the collecting device is also designed as a cross auger, wherein the cross auger is arranged in the intermediate bottom. In this case, “in the intermediate bottom” means that the cross auger is arranged between the intermediate bottom and the underfloor. In addition to its design as a push or pull bottom, the integrated discharge device can also be designed as a sliding panel, a so-called walking floor, or as an auger or scraper floor. In one embodiment of the discharge device as a push or pull bottom, it is preferably not arranged directly on the intermediate bottom, but is arranged in a floating manner. In such case, the preferred distance between the corresponding bottom and the push or pull bottom lies in the range between 5 and 10 cm. The floating design also has the advantages that less heat is generated and the wear due to friction is reduced. Furthermore, the force required to drive the push or pull bottom decreases, which is again advantageous for the autarkic operation of the mobile storage container and an optimal energy consumption.

For many bulk materials, it is advantageous that the bulk material is collected via a further conveying device, e.g. by means of an auger, which is also integrated into the container, after the container-integrated discharge device. This collecting conveyor is typically arranged below the discharge of the discharge device, but, according to the invention, it is also arranged above the underfloor of the container unit. This collecting conveyor can also be designed as a tube chain conveyor.

In the event that the collecting conveyor is not arranged at the end of the discharge device, the discharge device preferably conveys on each side of the collecting conveyor in the direction of said collecting conveyor. Therefore, two different conveying directions to the collecting conveyor are present in said one discharge device. If the discharge is designed as a push or pull bottom, it would mean, for example, that all the steep sides of the ladder bars, i.e. of the wedge end faces of the thrust wedges, face the collecting conveyor. The ladder bars, i.e. the thrust wedges between the cylinder and the collecting conveyor, convey when the cylinder is moved in the direction of the collecting conveyor, while the ladder bars convey behind the collecting conveyor when the cylinder is retracted.

In order to ensure that the collecting conveyor is not overburdened by the pressure of the overlying bulk material quantities, i.e. for its pressure relief, a roof-like strut can be arranged to be superimposed in the longitudinal direction of the collecting conveyor. Said roof-like element absorbs the compressive force of the overlying bulk material and deflects it directly into the walls, for example, also into the intermediate bottom.

The transfer of the bulk material from said collecting conveyor to the vertical conveyor integrated into the container unit is preferably carried out at one end of the collecting conveyor, but can, for example, also be provided centrally to said collecting conveyor. In addition to its design as a vertical auger, the vertical conveyor can also be designed as a scraper chain conveyor, a conveyor belt, or as a bucket conveyor. Depending on requirements, the vertical conveyor can be arranged on all sides of the container unit. In other words, it can be arranged in the front, in the rear, on the left sidewall, or on the right sidewall. The vertical conveyor can be mounted or designed in an inclined manner. However, it is also possible that the vertical conveyor is mounted essentially perpendicularly to one side of the container or is integrated into a sidewall. If the vertical conveyor is designed as a tube chain conveyor, it can be advantageous to combine the tube chain conveyor of the collecting device with that of the vertical conveyor and/or to design them as one unit. If the collecting device or the cross conveyor and the vertical conveyor are designed as a unit, said unit is designed such that, during the transport process, the conveyor is changeable or reversible.

At the discharge of the vertical conveyor, a chute is preferably arranged, with which the discharge height or the discharge point can be moved from the vertical conveyor in an area which is directly accessible for subsequent use, e.g. for winter service vehicles, gritting vehicles, or also stationary systems. It is preferably also possible that the vertical conveyor can drop material both behind and in front of the container, or also to the left or to the right, or also offset on several sides. This is particularly advantageous because, even with often limited spatial conditions, an optimal and variable functionality of the bulk material discharge and the bulk material transfer can be ensured. For increasing the practicability and flexibility of the mobile storage container according to the invention, the vertical conveyor can also be designed to be adjustable with regard to its incline and rotatable with regard to its drop direction, wherein this mobility is possible either as the entire conveyor or is realized only by rotating the ejection chute. The chute can also be provided with a further conveying aggregate, such as a further auger, a further tube chain conveyor, or a conveyor belt which can be movable or hinged, for example, to extend the horizontal and/or vertical conveying path without causing an increase of the dimensions for the transport.

In a further embodiment, the transfer point of the bulk material to the vertical conveyor is already designed as a movable joint.

Furthermore, a power supply unit for the drive of the discharge device, the cross conveyor, and the vertical conveyor as well as optionally existing further functional units is preferably arranged in the intermediate bottom. The energy supply unit is thus preferably integrated directly into the container unit. The power supply unit is preferably designed as a piston engine using gasoline or diesel fuel. The energy from the drive motor to the various drives of the different aggregates can be transferred electrically, pneumatically and/or hydraulically. A direct coupling of the drive motor with a hydraulic pump only requires an additional small generator in the form of, for example, an alternator for powering the controller. Alternatively, it is also possible to realize the power supply unit via the hydraulics of vehicles or via power take-offs of tractors for small electrical consumers, or by means of a battery. In such a case, the mobile storage container would be only partially autarkic regarding its operation and assurance of all integrated functionalities.

If the discharge device is designed as a pull or push bottom, the space, in which the push or pull cylinders are accommodated, can preferably also be used for accommodating a control cabinet and the power supply unit, e.g. the power supply aggregate and/or the hydraulic aggregates and further devices. Therefore, this space shall hereinafter be referred to as the supply space. In addition, the wall of the container facing the bulk material can be vertical as well as inclined. If the wall is inclined, the volume above can advantageously be used for storing the bulk material.

According to a development, at least a portion of the intermediate bottom is preferably positionable at a defined angle to the initial horizontal position by means of a drive, particularly an additional hydraulic cylinder drive. It is thus possible, due to gravity, to convey bulk material from the area, in which the intermediate bottom can be inclined, in the direction toward the discharge device. This is useful, for example, when a mobile storage container is to be completely emptied at the end of a utilization period. Such a device is advantageous, among others, because the mobile storage container does not have to be overturned for a complete emptying. For bulk materials that trickle away very easily, i.e. which form a low angle of repose, the installation of a push/pull floor can be advantageously forgone if the bottom is designed to be tiltable.

However, according to a further embodiment, it is preferably also possible that extendable hydraulic cylinders, by means of which the entire container unit can be tilted, are integrated into the underfloor of the container. This is once again a possible embodiment which is meaningful for a complete emptying of the container unit.

On the underfloor, the container unit preferably has rollers on receiving rails, and so the mobile storage container can be picked up, transported and unloaded in a conventional manner by trucks which are already used for transporting such containers as are regularly used, for example, for reusable material operations.

With regard to its outer dimensions, the container unit is further preferably designed for transport on public roads and in public areas in a standardized design, such as roll-off containers according to DIN30722, skip containers according to DIN20720, or sea containers according to IS0668.

Especially in winter service operations, the bulk material is preferably road salt, road sand, or road grit. This constitutes a preferred case of application for the mobile storage of grit during winter usage. It provides the particular positive effect or advantage that empty run times of the carrier vehicles can be significantly reduced with a corresponding spreader structure or spreader addition, and so the efficiency of the entire vehicle fleet operation within the framework of round-trip times stipulated and to be observed, and the reduction of operating costs of the commonly used carrier vehicles, is substantially improved. Since the mobile storage container can be transported to and set up at any location without having to make special foundation arrangements, the use of these mobile storage containers as the most economical and efficient solution lends itself to locations, where a central approach point for a gritting area, i.e. for gritting runs for the vehicles scattering the winter road grit or loose gravel, exist. In other words, the mobile storage containers can be arranged or placed, where a refilling of the containers is most effective because, in this respect, the length of the supply runs can also be optimized. This also ensures short empty runs and improves the overall efficiency of gritting and salting.

Since the mobile storage containers are easy to load especially when using grit, and the filling of spreaders is particularly simple, for example, when using cost-effective tractors, the flexibility and effectiveness of the mobile storage container according to the invention is increased. At the end of the operating time, for example, at the end of the winter season, the mobile storage containers are transported away entirely in one piece with the commercially available transport vehicles, wherein no prior disassembly of any attachments is required because the discharge device and the vertical conveyor are integrated into the container unit. Due to the fact that the respective functional units are integrated and do not protrude outwardly, i.e. do not constitute impeding objects, an optional stacking in large warehouses during the summer season and thus a space-saving storage are also readily possible.

According to one embodiment, it is also possible to use two containers for different bulk materials in a single container, i.e. to combine them in a single container unit of a mobile storage container, as is the case, e.g. with gritting trucks. Such a two-chamber spreader thus consists of a container for dry road salt and a container for road sand. For spreading road salt, trucks often already have a second container for brine in order to mix the road salt with brine directly during spreading and to salt the roads with this mixture. In principle, this is possible with the storage container according to the invention, wherein this dual chamber system can naturally also be applied directly to the spreader, and so two mobile storage containers can preferably be provided for respective components of a spreadable substance to be subsequently spread.

Preferably, the container unit is further provided with an integrated controller which additionally comprises a bidirectionally operating radio device. By means of the bidirectional radio device, desired parameters of the operation of the mobile storage container are transmitted via the integrated controller preferably by radio to a switchboard or a central control system and/or to the container. These parameters include filling states, load weight of the bulk material present in the container, unloading or loading releases, speed of removal, speed of filling, and the like. These parameters can be both stored and queried, wherein the corresponding parameters can be evaluated from past operating states, and optimal parameters and optimal operating conditions can be adjusted for currently running operating states of the mobile loading container. With the help of these data, the utilization of the bulk material from one container by different companies or communities is also possible, wherein each user can be identified on the container itself, for example, with a chip card or a PIN.

Further preferably, the container unit has a heating device at least for the discharge device, the container, and the vertical conveyor, and so it can be ensured especially during winter operation that there is no blockage of the functional units of the mobile loading container due to freezing of the bulk material which can quite possibly contain a certain amount of moisture.

According to a further embodiment, the container unit is designed to be weather- protected and/or frost-protected and/or actively heated, wherein the term weather-protected refers particularly to the container being waterproof and/or frost-protected. In addition, it is also possible that both the discharge device and the immediate storage area in the interior of the mobile storage container is lined, plated, insulated, or coated. In terms of a thermal insulation, such an insulation can be achieved, for example, with rock wool. A coating with wood, rubber, or plastic, or also textile concrete is conceivable. This coating is used as a thermal insulation but also contributes to the reduction of noise emissions. Without such an insulation, it is possible, e.g. for grit in the form of salt, loose gravel or granulate material, sand, or ash to clump together on contact with cold steel surfaces during the winter due to accumulating condensation water and the freezing of said condensation water. An inside coating with wood should preferably have a thickness of about 5 cm. If the mobile storage container has a noise-insulating coating, it is also readily possible to use said container even in residential areas without having to expect any usage restrictions. A frost protection of its heating system can, for example, be realized electrically via the integrated energy supply.

In the following, further advantages, details, and possible applications shall be described in detail using the following drawings. In the drawings:

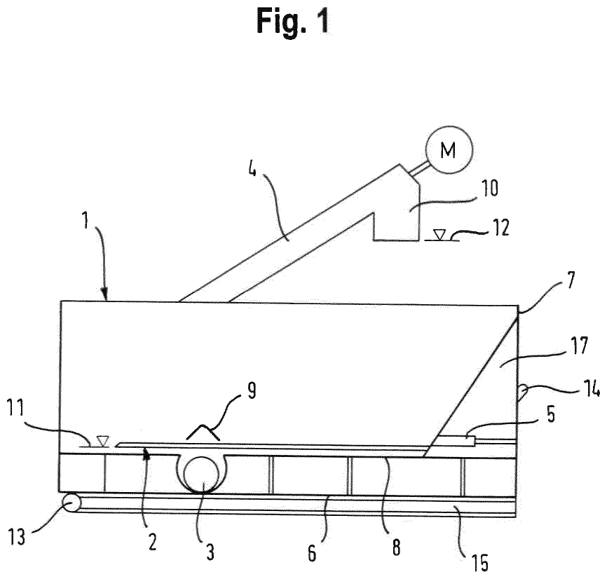

FIG. 1 shows a first embodiment of a mobile storage container according to the invention in the form of a grit container to be used for winter service;

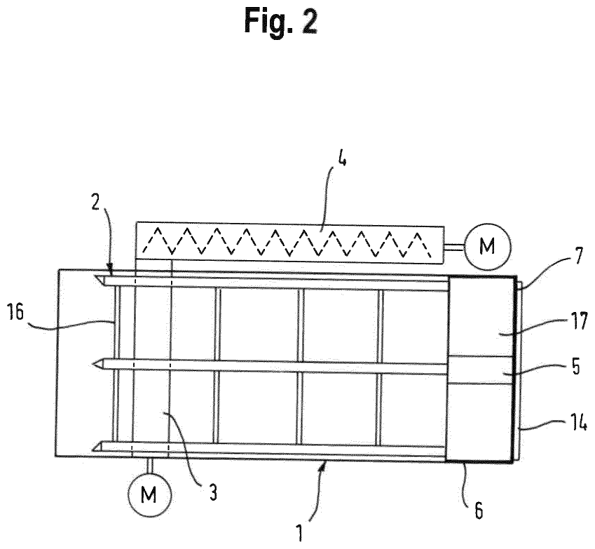

FIG. 2 shows a top view of a container unit of the mobile storage container according to FIG. 1;

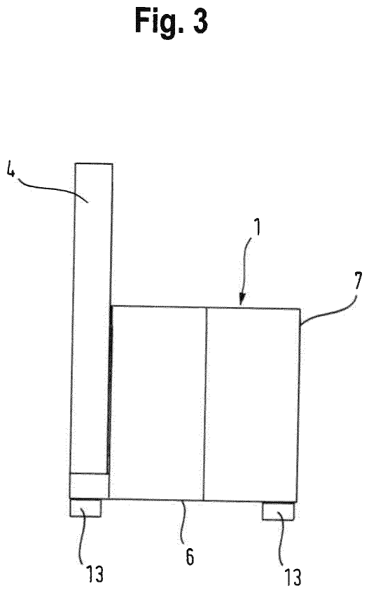

FIG. 3 shows a rear view of the container unit of the mobile storage container according to FIG. 1 and FIG. 2;

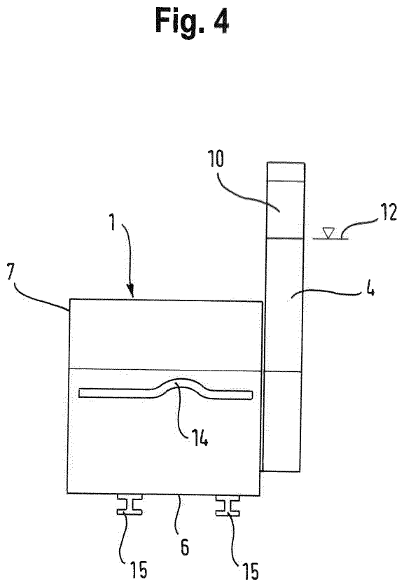

FIG. 4 shows a front view of the container unit of the mobile storage container according to FIGS. 1 to 3;

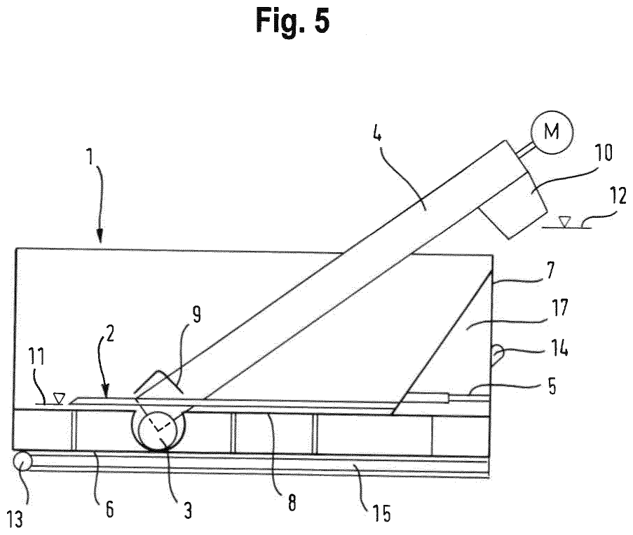

FIG. 5 shows a further embodiment of a mobile storage container in the form of a grit container for winter service;

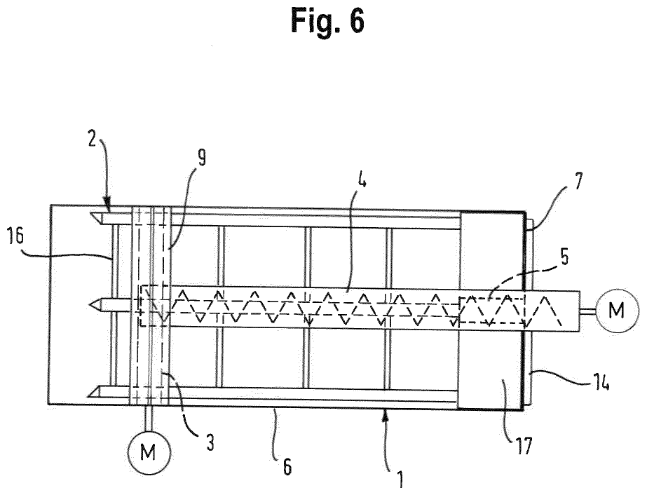

FIG. 6 shows a top view of the container unit of the mobile storage container according to FIG. 5;

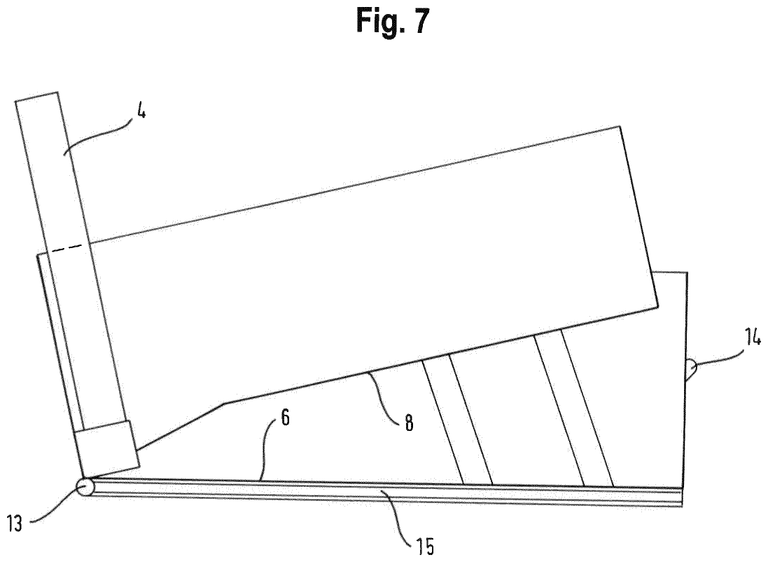

FIG. 7 shows a further embodiment of a mobile storage container with a tilting device;

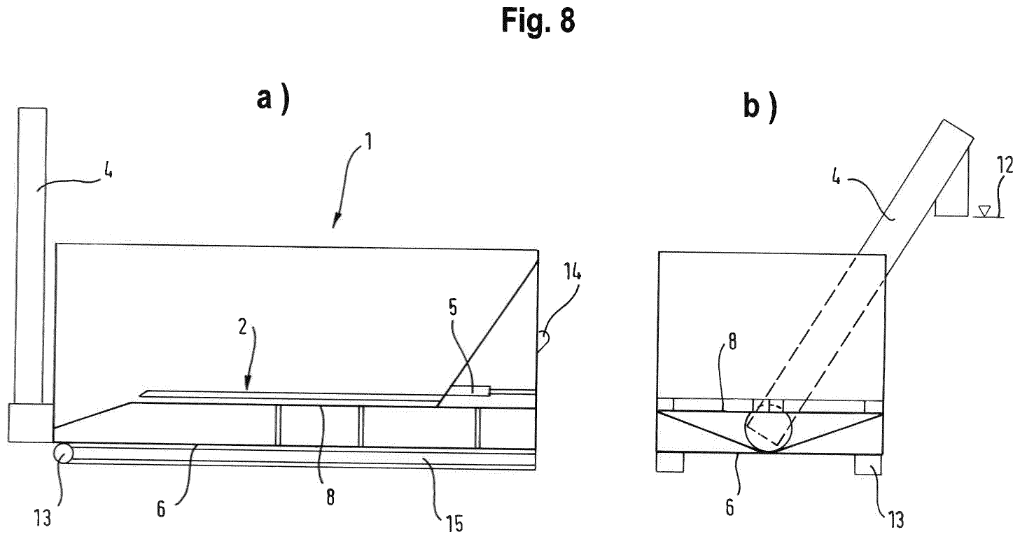

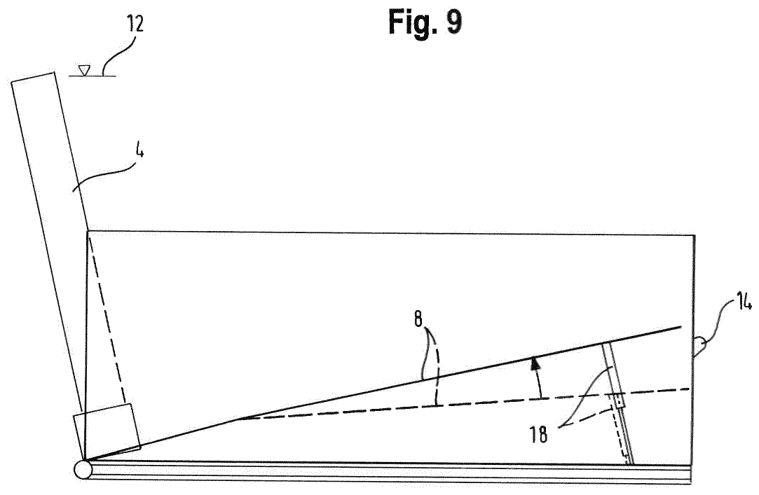

FIG. 8 a) and b) show yet a further embodiment of a mobile storage container with a push bottom on an provided intermediate bottom, and an intermediate bottom section inclined downwardly toward the discharge device in the form of a chute; and FIG. 9 shows yet a further embodiment of a mobile storage container with a section of the intermediate bottom of the container unit positionable at a defined angle.

FIG. 1 shows a side view of a first embodiment of a mobile storage container in the form of a grit container. This mobile storage container has a container unit with a discharge device in the form of a push floor 2 which conveys the grit at a discharge height 11 of the discharge device to a collecting device which, in this embodiment, is designed as a cross auger 3. Above the cross auger 3, a hood 9 is arranged which protects the cross auger 3 from the weight of the grit present in the mobile storage container; as a result, no excessive weight of the grit bears down on the cross auger 3. The cross auger 3 conveys the grit to a vertical conveyor 4 which is also designed as an auger. From the vertical conveyor, the grit reaches the ejection height 12 or drop height via an ejection chute 10, from where the grit conveyed to said position falls into a gritting vehicle arranged below the ejection chute, which is not shown here in order to simplify the drawing.

In this embodiment, the vertical conveyor 4 is arranged on the side of the container 1 of the container unit of the mobile storage container. The push bottom 2 is moved via a hydraulic cylinder 5. Because the drop height 12 of the vertical conveyor 4 lies above the discharge height 11 of the discharge device, it is possible that the mobile storage container with its underside or its underfloor, on which stabilizing rails 15 are possibly arranged, can be set down on fairly level ground of highly diverse consistency without having to build a foundation or pillars for mounting the storage container, and it is also possible to easily transport said container without conversion or fittings to another operating location by means of commercial trucks or other transport vehicles on public roads and in public areas. By means of the vertical conveyor as part of the mobile storage container, the grit can be transferred from the storage container to gritting vehicles. On its underfloor, the container unit itself has two rollers 13 and receiving rails 15. As a result, the underfloor 6 is additionally stabilized. The push bottom 2 moves on the intermediate bottom 8. The cross auger 3 is arranged in the space between the underfloor 6 and the intermediate bottom 8.

The bulk material is stored above the intermediate bottom 8 and delimited on the sides by the walls 7. A hook 14 of the roll-off container, by means of which the container is received by and transported with a truck, is located at the front side of the container unit 1. The supply space 17 is additionally used for accommodating a control cabinet and an optionally provided energy supply, e.g. a power generation unit and/or a hydraulic aggregate.

A significant advantage of this mobile storage container over conventional transport containers or conventional stationary storage containers is that the storage container has integrated all functional aggregates and can thus be used in a very flexible manner. With regard to its dimensions, the mobile storage container is additionally designed such that it does not exceed the measurements of standardized containers and can thus be transported problem-free and without a special permit in public road traffic from one operating location to another. The actual storage container thus has a dual function, namely the function of storing the grit, for example, for winter service tasks, and the mobility or the transport of the storage container from one operating location to another without installation or disassembly of possibly attached devices. Until now, this dual function has not been realized in this manner, since transport containers have not integrated functionalities because they are intended only for the transport of specific goods from a location A to a location B, whereas known storage containers are set up stationarily and therefore require a foundation or a mounting on pillars in order to ensure that these containers, which merely serve as a storage facility, can also be emptied appropriately in the sense that the bulk material stored in the container can be transferred to operational vehicles.

FIG. 2 shows a top view of the container unit 1 according to FIG. 1. The hydraulic cylinder 5, which moves the push bottom 2, lies above the underfloor 6. The push bottom 2 pushes the grit to the cross auger 3 which further conveys it to the vertical auger 4. At the front side 7 of the container of the container unit 1 of the mobile storage container, a hook 14 for transport is arranged. The last strut 16 of the push floor 2 has an opposite conveying direction to ensure that the grit is not pressed in on the rear wall of the container unit 1.

In addition, the supply space 17 is shown, in which a control unit and/or an energy supply unit are or can be arranged. Due to the fact that all functional aggregates are integrated into the container unit of the mobile storage container, the mobile storage container according to the invention has a high flexibility regarding its use and is also autarkic with regard to the realization of the functions required for operating this storage container.

FIG. 3 shows a rear view of the mobile storage container according to FIGS. 1 and 2. At the rear of the container of the container unit 1, a door is arranged, which can be opened to reach the interior of the container of the container unit 1. The rollers 13 of the container unit 1 are fastened to the underfloor 6, making the mobile storage container overall more mobile and flexible in its use. As shown in the embodiment in FIG. 1, the vertical auger 4 is fastened to the sidewall 7 of the container.

FIG. 4 finally shows a front view of the embodiment according to FIGS. 1 to 3. On the outer side of the container wall 7, the container unit 1 has a hook 14, and on the underfloor 6, it has receiving rails 15 which are both used for transport with a truck and also provide additional stability at the underfloor 6 of the container unit. FIG. 4 shows that the vertical auger 4 is attached outside on the side of the container unit and is used to convey the grit via the ejection chute 10 into a gritting vehicle (not depicted). The ejection or drop height 12 is also indicated in principle and lies clearly above the discharge height of the discharge device, which is arranged in the interior of the container of the container unit 1 of the mobile storage container. In this embodiment, the vertical auger 4 is designed to be hinged in order to comply with the permissible height for road transport.

FIG. 5 shows a further embodiment of a mobile storage container, e.g. a grit container 1. In this embodiment, the vertical auger 4 conveys the grit from the central area of the mobile storage container by means of a cross auger 3. A hydraulic cylinder 5 moves the push bottom 2 which is arranged on the intermediate bottom 8. This push bottom 2 conveys the grit to the cross auger 3. In this embodiment, the two halves of the cross auger 3 each convey the grit to the center and not to a selected side, as shown in FIG. 1. From the center of the cross auger 3, the vertical auger 4 conveys the grit via the ejection chute 10 onto a gritting vehicle (not depicted). The hook 14, which is fastened to the front side 7 of the container, the rollers 13 attached to the underfloor 6, and also the receiving rails 15 are provided for the transport of the mobile storage container with a normal truck which is designed for the transport of bins or containers. In this case, the vertical auger 4 is designed to be rotatable and can be lowered during transport to the area of the front wall 7.

FIG. 6 shows a top view of the mobile storage container with its container unit 1 according to FIG. 5. The hydraulic cylinder 5, which moves the push bottom 2, is arranged above the underfloor 6. The push bottom 2 pushes the grit to the auger 3 which is arranged below the intermediate bottom (not depicted in this drawing) and further conveys the grit to the vertical auger 4. In this embodiment, the vertical auger 4 conveys from the center of the container unit into the gritting vehicle (not depicted). The hook 14 for transport is visible at the front side 7 of the container unit. The last strut 16 of the push floor 2 has an opposite conveying direction to ensure that a pressing in of the grit on the rear wall of the container of the mobile storage container can be avoided. In this depiction, the cross auger 3 is not visible because the hood 9 (see, e.g. FIG. 5) is arranged above it.

In the embodiment shown in FIG. 7, extendable and retractable hydraulic cylinders are arranged between the receiving rails of the container or the container unit and the actual underfloor 6, said cylinders being used to bring the entire container into an inclined position, so that any bulk material or grit possibly still present on the intermediate bottom can be conveyed to the side into the chute and from there, via the discharge device, into the collecting device, from which the grit can be conveyed to the drop height 10 by means of the vertical conveyor.

However, it is also possible that the hydraulic cylinder is arranged between the underfloor 6 and the intermediate bottom 8, and so the intermediate bottom 8 together with the overlying container is brought into a tilted position when the container is lifted by means of the hydraulic cylinders. The hook 14 is once again shown on the front side 7 of the container unit.

In the embodiment according to FIG. 8, the side view a) and the cross-sectional view b) viewed in the longitudinal direction of the container unit 1 show an intermediate bottom 8 provided in the mobile storage container, on which a push bottom 2, drivable by means of the hydraulic cylinder 5, can be conveyed in the direction toward the collecting device for conveying the grit from the intermediate bottom into the chute. In this case, the collecting device is shown as a funnel without an active conveying member. The receiving rails 15 and the rollers 13 of the roll-off container are also shown on the underfloor 6. In this embodiment, the vertical conveyor 4 is attached to the rear side of the container unit. In the cross-sectional view, it can be seen that at the end, at which the vertical conveyor 4 is arranged, the grit is transported into a chute, from which it can be conveyed to the ejection height 12 by means of the vertical conveyor.

Finally, FIG. 9 depicts yet a further embodiment, which shows that the intermediate bottom 8 can be designed to be divided, and a potion of the intermediate bottom can be brought into an inclined position by means of an additional hydraulic cylinder, and so possibly present smaller quantities of grit can be conveyed, due to gravity, in the direction of the collecting device, from which the grit can be conveyed to the ejection height 12 by means of the vertical conveyor. This is particularly important if the mobile storage container is supposed to be emptied as completely as possible.

List of References Signs

1 Container unit

2 Push bottom

3 Cross auger

4 Vertical auger

5 Hydraulic cylinder push/pull bottom

6 Underfloor

7 Container walls/front wall

8 Intermediate bottom

9 Hood

10 Ejection chute

11 Drop height of the push bottom

12 Drop height of the vertical conveyor/vertical auger

13 Rollers of the roll-off container

14 Hook of the roll-off container

15 Receiving rails of the container

16 Reverse strut of the push bottom

17 Supply space

18 Hydraulic cylinder intermediate bottom

1. Storage container for bulk material in the form of a container unit which is dimensioned such that it can be transported without a special permit on public roads and in public areas and comprises a closed container with sidewalls, an underfloor, and an intermediate bottom arranged above the underfloor, characterized in that the container has a stiffness that allows for the container to be set up on any essentially level ground even in the filled state without pillar mounting and foundation, a discharge device for the bulk material and a cross conveyor are integrated into the containers, and a vertical conveyor, which is connected to the discharge device, is integrated into the container unit, wherein the bulk material, by means of the discharge device, can be dispensed at a discharge height from the container unit and transferred to the vertical conveyor, from which the bulk material can be dispensed at a drop height which is higher than the discharge height.

2. Storage container according to claim 1, characterized in that the vertical conveyor is a vertical auger and arranged in the interior of the container.

3. Storage container according to claim 1, characterized in that the vertical auger is arranged on the outside of the container.

4. Storage container according to claim 1, characterized in that the cross conveyor and the vertical conveyor are designed as a unit which realizes a change in the conveying direction during the transport process.

5. Storage container according to claim 1, characterized in that the discharge device is designed as a push/pull bottom and has ladder rails and ladder bars.

6. Storage container according to claim 5, characterized in that there is a distance, particularly of at least 5 cm, between the push bottom and the intermediate bottom.

7. Storage container according to claim 1, characterized in that the cross conveyor is designed as a cross auger or a tube chain conveyor and arranged in the intermediate bottom.

8. Storage container according to claim 1, characterized in that a supply space is provided, in which an energy supply unit for driving the discharge device, the cross conveyor, and the vertical conveyor is arranged.

9. Storage container according to claim 1, characterized in that, on the underfloor, the container unit has rollers on receiving rails.

10. Storage container according to claim 1, characterized in that at least a portion of the intermediate bottom is positionable at a defined angle to the initial horizontal position by means of a drive, particularly a hydraulic cylinder drive.

11. Storage container according to claim 1, characterized in that hydraulic cylinders, which are extendable from the underfloor of the container and by means of which the container unit can be tilted, are integrated into the underfloor.

12. Storage container according to claim 1, characterized in that, with regard to its outer dimensions, the container unit is standardized for transport on public roads and in public areas, such as roll-off containers according to DIN 30722, skip containers according to DIN 20720, or sea containers according to ISO 668.

13. Storage container according to claim 1, characterized in that the bulk material is road salt, road sand, or road grit.

14. Storage container according to claim 1, characterized in that the container unit is provided with a bidirectionally operating radio device, by means of which filling states and unloading or loading releases can be transmitted and/or queried and/or controlled.

15. Storage container according to claim 1, characterized in that the container unit comprises a heating device at least for the discharge device, the container, and the vertical conveyor.

16. Storage container according to claim 1, characterized in that the container unit is designed to be weather- protected, particularly waterproof and/or frost-protected.

17. Storage container according to claim 1, characterized in that the container is provided with a lid or a tarpaulin.
